(19) United States
(12) Patent Application Publication
(10) Pub. No.: US 2026/0302550 A1
(43) Pub. Date: Oct. 1, 2026

(54) Secondary Battery

(71) Applicant: LG Energy Solution, Ltd., Seoul (KR)

(72) Inventors: Hak Soo Lee, Daejeon (KR); Won Jae Lee, Daejeon (KR); Hee Moon Lee, Daejeon (KR); Wan Seop Kim, Daejeon (KR); Jeong Jin Kim, Daejeon (KR); Hyeon Uk Park, Daejeon (KR); Young Gon Lim, Daejeon (KR); Ji Su Hong, Daejeon (KR)

(73) Assignee: LG Energy Solution, Ltd., Seoul (KR)

(21) Appl. No.: 19/576,500

(22) Filed: Mar. 24, 2026

(30) Foreign Application Priority Data
Mar. 25, 2025 (KR) 10-2025-0038280
Jul. 22, 2025 (KR) 10-2025-0099304
Feb. 19, 2026 (KR) 10-2026-0030799
Mar. 24, 2026 (KR) 10-2026-0052740

(51) Int. Cl. H01M 50/533; H01M 50/176; H01M 50/30; H01M 50/528; H01M 50/536; H01M 50/54; H01M 50/586; H01M 50/595

(52) U.S. Cl. CPC H01M 50/533; H01M 50/176; H01M 50/394; H01M 50/528; H01M 50/536; H01M 50/54; H01M 50/586; H01M 50/595

(57) ABSTRACT

A secondary battery includes a casing, a plurality of electrode assemblies, electrode tab bundles formed on the electrodes of the plurality of electrode assemblies, respectively, a current collector coupled to the electrode tab bundles of the plurality of electrode assemblies and a cap assembly is provided. The current collector includes a main support plate on which a connection terminal and a plurality of branches extending from a side of the main support plate along a width direction of the electrode assemblies. The plurality of branches includes a first branch and a second branch that are spaced apart from each other in a thickness direction of the electrode assembly stack. The current collector is asymmetrical about a virtual center line extending in the width direction of the electrode assemblies.

### CROSS-REFERENCE TO RELATED APPLICATION

The present application claims the benefit of foreign priority of Korean Patent Application No. 10-2026-0052740 filed Mar. 24, 2026, 10-2026-0030799 filed Feb. 19, 2026, 10-2025-0099304, filed Jul. 22, 2025, and 10-2025-0038280, filed Mar. 25, 2025, in the Republic of Korea, the entire disclosures of which are incorporated by reference herein.

### BACKGROUND

### 1. Technical Field

The present disclosure relates to a secondary battery capable of being charged and discharged.

### 2. Related Art

Recently, as demand for portable electronic products such as laptops, video cameras, and mobile phones has rapidly increased and the development of electric vehicles, energy storage batteries, robots, satellites, and the like has become more active, research has been actively conducted on high-performance secondary batteries capable of repeated charging and discharging.

Currently commercialized secondary batteries include nickel-cadmium batteries, nickel-metal hydride batteries, nickel-zinc batteries, and lithium secondary batteries. Among these, the lithium secondary batteries are drawing attention because they exhibit little or no memory effect compared to nickel-based secondary batteries, allow free charging and discharging, have a very low self-discharge rate, and provide high energy density.

Such lithium secondary batteries mainly use a lithium-based oxide and a carbon material as a positive electrode active material and a negative electrode active material, respectively. In addition, the lithium secondary battery includes a positive electrode plate and a negative electrode plate on which the positive electrode active material and the negative electrode active material are respectively coated, an electrode assembly in which the positive electrode plate and the negative electrode plate are disposed with a separator interposed therebetween, and an outer casing configured to hermetically accommodate the electrode assembly together with an electrolyte.

The lithium secondary battery may be classified, according to the shape of a battery casing, into a can-type secondary battery in which an electrode assembly is embedded in a metal can, and a pouch-type secondary battery in which an electrode assembly is embedded in a pouch formed of an aluminum laminate sheet. The can-type secondary battery may also be classified into a cylindrical battery and a prismatic battery according to the shape of the metal can.

In the case of the prismatic battery, a plurality of thin-film tabs connected to an electrode plate are gathered together and pre-welded, and then welded again to a current collector. As the thickness of the electrode assembly increases, the length of the thin-film tabs required for pre-welding increases, and there is a need to stably couple such thin-film tabs to the current collector.

### SUMMARY

Accordingly, an object of some aspects of the present disclosure is to provide a secondary battery that can increase energy density per unit volume by reducing a space occupied by a thin-film tab or the like within a casing.

Another object of some aspects of the present disclosure is to provide a secondary battery that can reduce resistance to current caused by an increase in a length of a thin film tab in a process in which current is delivered to an electrode assembly through an external terminal.

A further object of some aspects of the present disclosure is to provide a secondary battery that can stably connect a thin-film tab to a current collector as the number of electrode assemblies increases.

A secondary battery according to an aspect of the present disclosure may include a casing, an electrode assembly stack having plurality of electrode assemblies accommodated in the casing, each electrode assembly including a plurality of electrodes having electrode tabs, a plurality of electrode tab bundles formed from the electrode tabs of the plurality of electrode assemblies, respectively, a current collector coupled to the plurality of electrode tab bundles, and a cap assembly sealing the casing and having an external terminal connected to the current collector, and the current collector may include a main support plate on which a connection terminal connected to the external terminal is positioned, and a plurality of branches extending from a side of the main support plate along a width direction of the electrode assemblies, the electrode tab bundles may be coupled thereto. The plurality of branches may include a first branch and a second branch spaced apart from each other in a thickness direction of the electrode assembly stack, where the thickness direction intersects the width direction of the electrode assemblies. The current collector may be asymmetrical about a virtual center line extending in the width direction of the electrode assemblies.

Each of the electrode tab bundles may be formed by gathered electrode tabs welded together over a first welding region at ends of the electrode tab bundles.

The ends of each the electrode tab bundle may be welded on the plurality of branches over a second welding region on each electrode tab bundle. A second welding region formed at the ends by the second welding may at least partially overlap a first welding region formed at the ends by the first welding.

The second welding region may be located within the first welding region.

An area of the first welding region may be 1.1 to 5 times an area of the second welding region.

A length of the first welding region in the width direction may be greater than a length of the second welding region in the width direction of the electrode assemblies.

Different numbers of the electrode tab bundles may be welded to each of the first branch and the second branch.

Two electrode tab bundles of the plurality of electrode tab bundles may be welded to the first branch, and one electrode tab bundle of the plurality of electrode tab bundles may be welded to the second branch.

The two electrode tab bundles and the one electrode tab bundle may be arranged in a line along the thickness direction of the electrode assembly stack.

The two electrode tab bundles may be bent towards each other along the thickness direction of the electrode assembly stack and may be welded onto the first branch, and the one electrode tab bundle may be bent in the same direction as an adjacent one of the two electrode tab bundles and the one electrode tab bundle may be welded onto the second branch.

The plurality of electrode assemblies may include three electrode assemblies arranged in parallel along the thickness direction of the electrode assembly stack, and an electrode tab bundle of the plurality of electrode tab bundles may be disposed on each of the three electrode assemblies.

A first width of the first branch in the thickness direction may be greater than a second width of the second branch in the thickness direction of the electrode assembly stack.

The first width of the first branch and the second width of the second branch may satisfy Equation 1 below.

A first area of the first branch and a second area of the second branch may satisfy Equation 2 below.

A separation distance between the first branch and the second branch may satisfy Equation 3 below.

The electrode tab bundles may be welded to upper surfaces of the first branch or the second branch.

The same number of electrode tab bundles may be welded to the first branch and the second branch.

The connection terminal may be disposed adjacent to a side end of the electrode assembly in the width direction of the electrode assemblies.

The connection terminal may have a cylindrical shape.

The main support plate and the plurality of branches may lie in the same plane.

A flatness of the main support plate and the plurality of branches may be 0.05 to 2.

An overall length of the current collector in the width direction of the electrode assemblies may be 0.5 to 0.75 times a length of the electrode assembly stack in the width direction of the electrode assemblies.

An insulating holder supporting the current collector may be welded to a lower portion of the current collector.

At least a portion of each electrode tab bundle may be bent to be parallel to an upper surface of the electrode assembly stack, and an insulating tape may be disposed between the current collector and the upper surface of the electrode assembly.

The secondary battery may further include a vent portion formed in the casing or the cap assembly, and a longitudinal axis direction of the vent portion may be parallel to the width direction of the electrode assemblies or may intersect the width direction of the electrode assemblies.

A second welding region of each electrode tab bundle may be positioned along an edge of a respective branch of the plurality of branches.

In the secondary battery the plurality of electrode tab bundles may be a first plurality of electrode tab bundles and the current collector may be a first current collector, and the secondary battery may further include a second plurality of electrode tab bundles formed from electrode tabs of the plurality of electrode assemblies, respectively, the second current collector may include a main support plate on which a connection terminal connected to the external terminal is positioned, and a plurality of branches extending from a side of the main support plate along a width direction of the electrode assemblies. The second plurality of electrode tab bundles may be coupled thereto. The plurality of branches may include a first branch and a second branch that are spaced apart from each other in a thickness direction of the electrode assembly stack with the thickness direction intersecting the width direction of the electrode assemblies. The current collector may be asymmetrical about a virtual center line extending in the width direction of the electrode assemblies.

The first current collector may have a shape corresponding to the second current collector.

The first current collector and the second current collector may be arranged in mirror symmetry on the electrode stack with respect to a thickness direction of the electrode assembly stack.

The first current collector and the second current collector may be arranged symmetrically on the electrode assembly stack with respect to a virtual center point on an upper surface of the electrode assembly stack.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a perspective view illustrating a secondary battery according to a first aspect of the present disclosure;

FIG. 2 is a cross-sectional view taken along line A1-A1 of FIG. 1;

FIG. 3 is a perspective view illustrating a state in which a current collector is coupled to a plurality of electrode assemblies according to the first aspect of the present disclosure;

FIG. 4 is a plan view illustrating the plurality of electrode assemblies of FIG. 3;

FIG. 5 is a plan view illustrating a state in which an electrode tab bundle is coupled to the current collector according to the first aspect of the present disclosure;

FIG. 6 is a perspective view illustrating the current collector according to the first aspect of the present disclosure;

FIG. 7 is a cross-sectional view taken along line A2-A2 of FIG. 3;

FIG. 8 is a side elevation view illustrating an electrode in which the electrode tab bundle is formed according to the first aspect of the present disclosure;

FIG. 9 is a side elevation view illustrating a state in which the electrode tab bundle of the plurality of electrode assemblies is subjected to first welding according to the first aspect of the present disclosure;

FIG. 10 is a perspective view illustrating a current collector according to a second aspect of the present disclosure;

FIG. 11 is a cross-sectional view illustrating a state in which the current collector of FIG. 10 is coupled to an electrode assembly;

FIG. 12 is a plan view illustrating a state in which an electrode tab bundle is coupled to a current collector according to a third aspect of the present disclosure;

FIG. 13 is a side elevation view illustrating an electrode in which an electrode tab bundle is formed according to the third aspect of the present disclosure;

FIG. 14 is a plan view illustrating a state in which a current collector is coupled to a plurality of electrode assemblies according to a fourth aspect of the present disclosure;

FIG. 15 is a partial plan view illustrating a state in which a current collector is coupled to a plurality of electrode assemblies according to a fifth aspect of the present disclosure;

FIG. 16 is a partial plan view illustrating a state in which a current collector is coupled to a plurality of electrode assemblies according to a sixth aspect of the present disclosure;

FIG. 17 is a partial plan view illustrating a state in which a current collector is coupled to a plurality of electrode assemblies according to a seventh aspect of the present disclosure;

FIG. 18 is a partial plan view illustrating a state in which a current collector is coupled to a plurality of electrode assemblies according to an eighth aspect of the present disclosure;

FIG. 19 is a perspective, partially-exploded view illustrating a vent portion according to a ninth aspect of the present disclosure, as viewed from below;

FIG. 20 is a perspective view illustrating a secondary battery according to a tenth aspect of the present disclosure;

FIG. 21 is a plan view illustrating the secondary battery of FIG. 20 as viewed from above; and

FIG. 22 is a perspective, partially-exploded view illustrating a vent portion according to an eleventh aspect of the present disclosure, as viewed from below.

### DETAILED DESCRIPTION

Since the present disclosure may be modified in various forms and may have various aspects, particular aspects will be illustrated in the accompanying drawings and described in detail with reference to the drawings. However, this is not intended to limit the present disclosure to particular modes of practice, and it is to be appreciated that all changes, equivalents, and substitutes that do not depart from the spirit and technical scope of the present disclosure are encompassed in the present disclosure.

The terminology used herein is for the purpose of describing particular aspects only and is not intended to be limiting the present disclosure. In the present disclosure, the singular forms are intended to include the plural forms as well, unless the context clearly indicates otherwise. It will be further understood that the terms “comprise”, “include”, “have”, etc. when used in this specification, are intended to specify the presence of stated features, integers, steps, operations, elements, components, and/or combinations of them but do not preclude the presence or addition of one or more other features, integers, steps, operations, elements, components, and/or combinations thereof.

Hereinafter, preferred aspects of the present disclosure will be described in detail with reference to the accompanying drawings. It should be noted that like reference numerals refer to like elements throughout the attached drawings. Details of well-known configurations and functions may be omitted to avoid unnecessarily obscuring the gist of the present disclosure. For the same reason, in the accompanying drawings, some elements are enlarged, omitted, or depicted schematically.

Hereinafter, a secondary battery according to a first aspect of the present disclosure will be described.

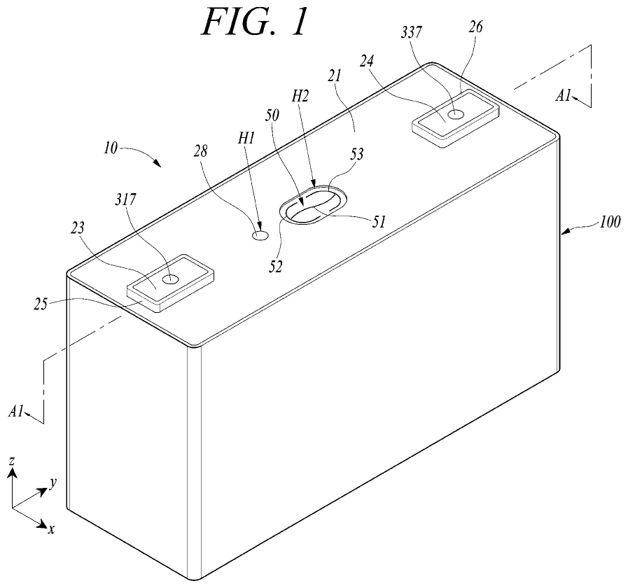

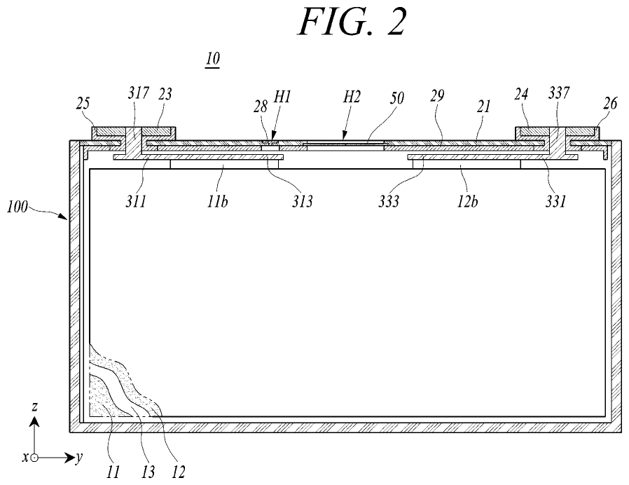

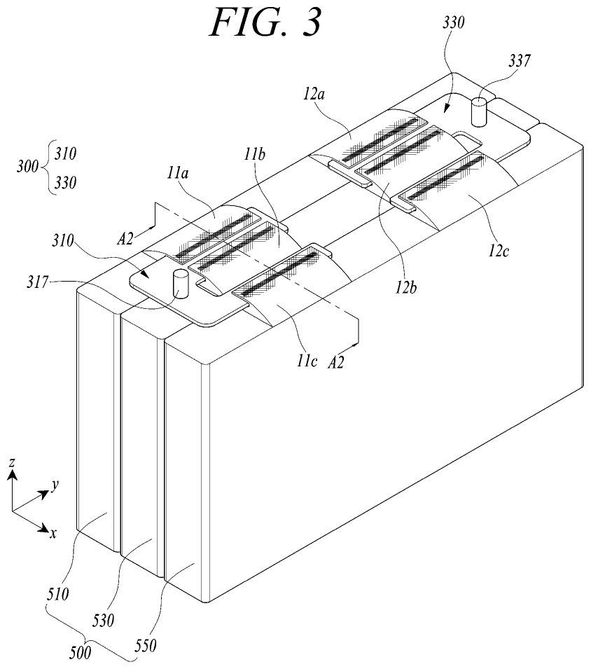

FIG. 1 is a is a perspective view illustrating a secondary battery according to a first aspect of the present disclosure, FIG. 2 is a cross-sectional view taken along line A1-A1 of FIG. 1, and FIG. 3 is a perspective view illustrating a state in which a current collector is coupled to a plurality of electrode assemblies according to the first aspect of the present disclosure.

Referring to FIGS. 1 to 3, a secondary battery 10 according to an aspect of the present disclosure includes an electrode assembly stack 500 having a plurality of electrode assemblies 510, 530, 550 each including a positive electrode 11 and a negative electrode 12, a casing 100 accommodating the electrode assembly stack 500, a cap plate 21 coupled to the casing 100, external terminals 23 and 24 installed on the cap plate 21, an upper insulator 29 disposed between the cap plate 21 and the electrode assembly stack 500, and a vent portion 50 disposed on the cap plate 21.

Each of the electrode assemblies 510, 530, 550 may perform charging and discharging, and may be implemented in various forms, such as an all-solid-state electrode assembly, a lithium-ion electrode assembly, or a sodium-ion electrode assembly.

Each electrode assembly 510, 530, 550 may include a positive electrode 11, a negative electrode 12, and a separator 13 interposed between the positive electrode 11 and the negative electrode 12, and the positive electrode 11, the separator 13, and the negative electrode 12 may be configured in a stacked structure or a wound structure in a jelly-roll form.

Further, each electrode assembly 510, 530, 550 may have a structure in which the positive electrode(s) 11 and the negative electrode(s) 12 are alternately inserted between parts of the separator 13 folded in a zigzag shape. Further, each electrode assembly 510, 530, 550 may be implemented in various forms, such as an all-solid-state type that does not include a separator.

The positive electrode(s) 11 and the negative electrode(s) 12 may each include a coating portion, which is a region where an active material is applied onto a metal foil or conductive layer, and an uncoated portion where the active material is not applied. Positive-electrode uncoated portions may form first electrode tab bundles 11a, 11b, and 11c that may protrude from side ends of the positive electrode(s) 11, and negative-electrode uncoated portions may form second electrode tab bundles 12a, 12b, and 12c that may protrude from side ends of the negative electrode 12. The positive-electrode uncoated portions 11a, 11b, and 11c and the negative-electrode uncoated portions 12a, 12b, and 12c may protrude in the same direction toward the cap plate 21, that is, protrude in a longitudinal direction of the respective electrode assembly 510, 530, 550, corresponding to a z-axis direction.

The positive-electrode uncoated portions 11a, 11b, and 11c and the negative-electrode uncoated portions 12a, 12b, and 12c may be formed in a tab shape and may be spaced apart from each other in a width direction of the respective electrode assembly 510, 530, 550, corresponding to a y-axis direction. The positive-electrode uncoated portions forming first electrode tab bundles 11a, 11b, and 11c and the negative-electrode uncoated portions forming second electrode tab bundles 12a, 12b, and 12c may be stacked in a thickness or stacking direction of the respective electrode assembly 510, 530, 550, corresponding to an x-axis direction.

Further, the first electrode tab bundle 11a, 11b, and 11c may be electrically connected to a first external terminal 23 via a first current collector 310, and the second electrode tab bundle 12a, 12b, and 12c may be electrically connected to a second external terminal 24 via a second current collector 330. Detailed descriptions of a coupling structure between the first electrode tab bundle 11a, 11b, and 11c and the first current collector 310 and a coupling structure between the second electrode tab bundle 12a, 12b, and 12c and the second current collector 330 according to the present aspect will be provided later.

The separator 13 is disposed between the positive electrode 11 and the negative electrode 12, and the separator 13 prevents a short circuit and enables movement of ions. When the secondary battery 10 is implemented as an all-solid-state battery, a solid electrolyte may be positioned between the positive electrode 11 and the negative electrode 12 instead of the separator 13.

The casing 100 may be formed in a box shape having an internal space accommodating the electrode assembly stack 500. The casing 100 may be made in various shapes, such as a prismatic shape or a cylindrical shape. A plurality of electrode assemblies 510, 530, 550 may be inserted into the casing 100.

An electrolyte may be accommodated together with the electrode assembly stack 500 inside the casing 100. The electrolyte may be in a liquid, solid, or gel state.

The cap plate 21 may be formed as a plate member covering an opening of the casing 100 and may have a shape corresponding to a shape of the opening of the casing 100. The cap plate 21 may be fixed to the casing 100, such as by welding or adhesive.

An electrolyte injection hole H1 for injecting the electrolyte and a vent hole H2 in which a vent portion 50 is installed may be formed in the cap plate 21. A sealing plug 28 for closing the electrolyte injection hole H1 may be installed in the electrolyte injection hole H1, and the vent portion 50 that is opened at a preset pressure may be formed in the vent hole H2.

In this aspect, the vent portion 50 may have a longitudinal dimension extending along the width direction corresponding to the y-axis direction. The vent portion 50 may have a shape elongated in the width direction (y-axis direction), such as a rectangular shape, an oblong shape, or a rounded-rectangle shape.

Further, the vent portion 50 may be fixed to the cap plate 21, such as by welding or adhesive. The vent portion 50 may be fixed to a lower surface of the cap plate 21, or may be fixed to an upper surface of the cap plate 21.

The vent portion 50 may include two side notches 52 and 53 and a connection notch 51 connecting the side notches 52 and 53. The connection notch 51 and the side notches 52 and 53 may be formed as elongated grooves, and may be grooves having a trapezoidal cross-sectional shape. However, the present disclosure is not limited thereto, and the connection notch 51 and the side notches 52 and 53 may have various cross-sectional shapes, such as a triangular shape or an arcuate shape.

The connection notch 51 may be formed as a curved line to form a wavy shape or an S-shape. The two side notches 52 and 53 may be formed in an arcuate shape and may be convex in opposite directions, while protruding convexly toward an outer side in the width direction (y-axis direction) of the vent portion 50. The first side notch 52 and the second side notch 53 may be connected to the connection notch 51, and the first side notch 52 and the second side notch 53 may have the same structure and be arranged in line symmetry.

In this aspect, the vent portion 50 is formed to longitudinally extend along the width direction (y-axis direction). Since a distance between the first current collector 310 and the second current collector 330 is sufficiently large, gas may be smoothly discharged without interference from the first current collector 310 and the second current collector 330 even when the vent portion 50 is disposed in the width direction (y-axis direction).

An upper insulator 29 may be disposed under the cap plate 21, and the upper insulator 29 may be formed as a plate parallel to the cap plate 21 and may extend in the width direction (y-axis direction) of the electrode assembly stack 500.

The external terminals 23 and 24 may be coupled to the cap plate 21, and one or two external terminals 23 and 24 may be installed on the cap plate 21. When two external terminals 23 and 24 are installed on the cap plate 21, a first external terminal 23 may be configured as a positive terminal, and a second external terminal 24 may be configured as a negative terminal. When a single external terminal is installed on the cap plate 21, the casing 100 may be charged as a negative electrode.

The first external terminal 23 and the second external terminal 24 may be formed in a plate shape. A gasket 25 for insulation may be disposed between the first external terminal 23 and the cap plate 21, and a gasket 26 for insulation may also be disposed between the second external terminal 24 and the cap plate 21. In addition, the gaskets 25 and 26 may extend downward and be positioned between the current collectors 310 and 330 and the cap plate 21. Each of the gaskets 25 and 26 may be formed as a single member or may be divided into a plurality of parts. A rivet (not shown) may be used to secure the first and second external terminals and the gaskets 25 and 26 to the cap plate 21. The gaskets 25 and 26 may also be made of conductive material such as metal.

The first external terminal 23 and the second external terminal 24 may be formed in a plate shape, and a hole into which a connection terminal 317 or 337 of the first current collector 310 or the second current collector 330 is inserted may be formed at a central portion of the first external terminal 23 or the second external terminal 24.

In this aspect, the electrode assembly stack 500 may include three electrode assemblies. Each of the electrode assemblies 510, 530, and 550 may be an electrode assembly having the same internal structure.

The plurality of electrode assemblies 510, 530, and 550 may be stacked along the thickness direction (x-axis direction) of the electrode assembly stack 500. Each of the plurality of electrode assemblies 510, 530, and 550 may include a first electrode tab bundle 11a, 11b, and 11c corresponding to the respective positive electrode(s) and a second electrode tab bundle 12a, 12b, and 12c corresponding to the respective negative electrode(s). Each of the electrode assemblies 510, 530, and 550 may be provided with the same number of first electrode tab bundles 11a, 11b, and 11c and the same number of second electrode tab bundles 12a, 12b, and 12c. That is, in each of the first electrode assembly 510, the second electrode assembly 530, and the third electrode assembly 550, the first electrode tab bundles 11a, 11b, and 11c may include an identical number of stacked tabs. Also, in each of the first electrode assembly 510, the second electrode assembly 530, and the third electrode assembly 550, the second electrode tab bundles 12a, 12b, and 12c may include an identical number of stacked tabs.

The plurality of first electrode tab bundles 11a, 11b, and 11c may be arranged in a line along the thickness direction (x-axis direction) of the electrode assembly stack 500, and the plurality of second electrode tab bundles 12a, 12b, and 12c may also be arranged in a line along the thickness direction (x-axis direction) of the electrode assembly stack. The plurality of first electrode tab bundles 11a, 11b, and 11c may be positioned at one side end along the width direction (y-axis direction) of the electrode assembly stack 500, while the plurality of second electrode tab bundles 12a, 12b, and 12c may be positioned at the other side end along the width direction (y-axis direction) of the electrode assembly stack 500.

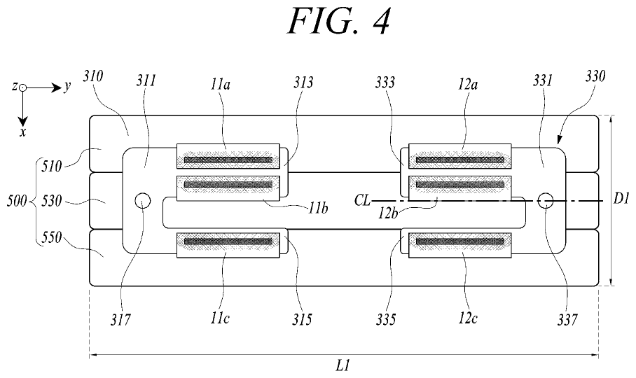

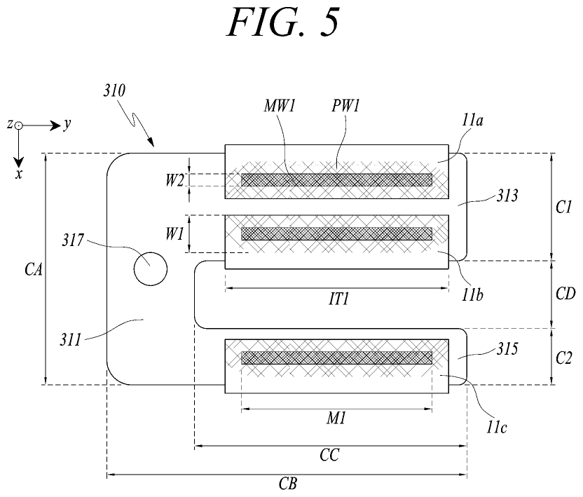

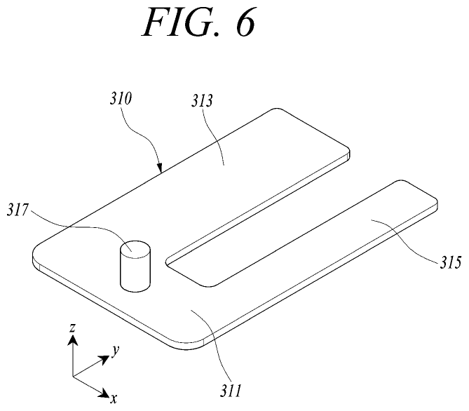

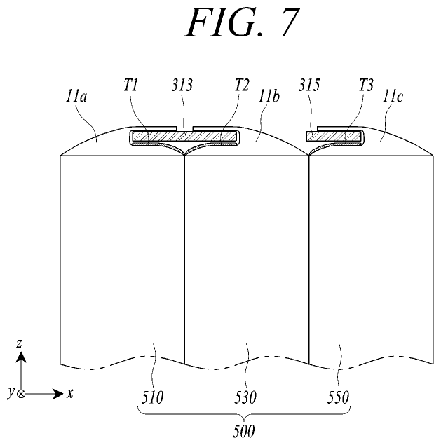

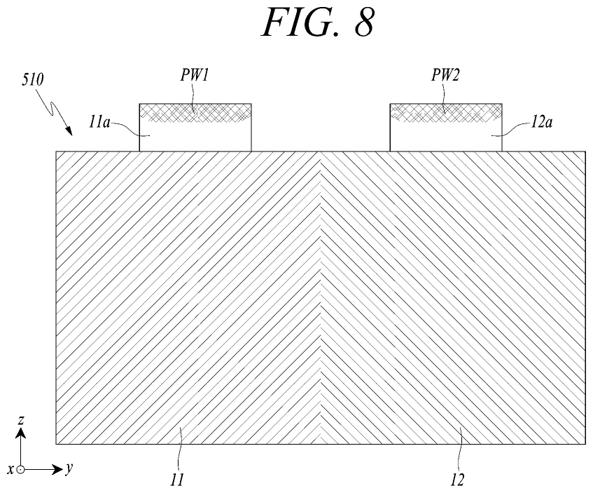

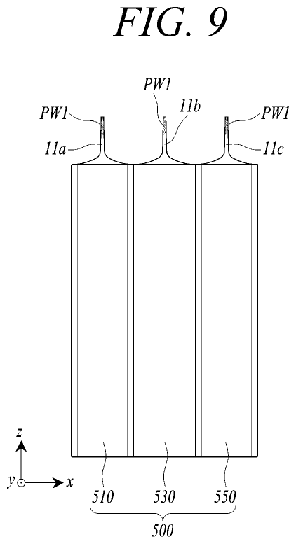

FIG. 4 is a plan view illustrating the plurality of electrode assemblies 510, 530, 550 of FIG. 3. FIG. 5 is a plan view illustrating a state in which the electrode tab bundles 11a, 11b, 11c, are coupled to the current collector 310 according to the first aspect of the present disclosure. FIG. 6 is a perspective view illustrating the current collector 310 according to the first aspect of the present disclosure. FIG. 7 is a cross-sectional view taken along line A2-A2 of FIG. 3, FIG. 8 is a side view illustrating one electrode assembly 510 in which the electrode tab bundle is formed according to the first aspect of the present disclosure. FIG. 9 is a second side view illustrating a state in which the electrode tab bundles 11a, 11b, 11c (with 12a, 12b, 12c being obscured in the drawing view) of the plurality of electrode assemblies 510, 520, 550 are subjected to first welding according to the first aspect of the present disclosure.

Referring to FIGS. 4 to 9, in this aspect, the first electrode assembly 510, the second electrode assembly 530, and the third electrode assembly 550 are stacked along the thickness direction (x-axis direction) of the electrode assembly stack 500, the first electrode tab bundles 11a, 11b, and 11c of the positive electrodes 11 may be coupled to the first current collector 310, and the second electrode tab bundles 12a, 12b, and 12c of the negative electrodes 12 may be coupled to the second current collector 330.

In this aspect, the first current collector 310 may include a main support plate 311 and a plurality of branches 313 and 315. The main support plate 311 may be a flat plate-shaped member that supports the first connection terminal 317. The first connection terminal 317 may be positioned on an upper surface of the main support plate 311, and the first connection terminal 317 may be electrically connected to the first external terminal 23 coupled to the cap plate 21. In this case, the first connection terminal 317 may have a cylindrical shape.

The plurality of branches 313 and 315 may be formed on a side surface of the main support plate 311. Each of the plurality of branches 313 and 315 may extend along a width direction (y-axis direction). The plurality of branches 313 and 315 may also be flat plate-shaped members, similar to the main support plate 311. In this aspect, the main support plate 311 and the plurality of branches 313 and 315 of the first current collector 310 may be formed as a single flat plate-shaped member, that is, may lie in the same plane. In other examples, the plurality of branches may lie in a different plane from the main support plate or may have a different thickness than the main support plate.

The first branch 313 and the second branch 315 may have substantially rectangular shapes elongated in the width direction (y-axis direction). Thereby, the first current collector 310 according to this aspect may have an approximately U-shaped configuration.

The plurality of branches 313 and 315 may include the first branch 313 and the second branch 315 that are respectively formed to extend from a side surface of the main support plate 311. The first branch 313 and the second branch 315 may be spaced apart from each other along the thickness direction (x-axis direction). In this case, the first branch 313 and the second branch 315 may be spaced apart by a separation distance CD.

In this aspect, a width of the first branch 313 and a width of the second branch 315 may be different from each other, such that the current collector is asymmetrical about a virtual center line CL extending in the width direction (y-axis direction). The first branch 313 may have a first width C1, and the second branch 315 may have a second width C2. Here, the first width C1 and the second width C2 respectively represent widths of the first branch 313 and the second branch 315 in the thickness direction (x-axis direction).

Specifically, the first width C1 of the first branch 313 may be greater than the second width C2 of the second branch 315. Thereby, two electrode tab bundles, that is, the first electrode tab bundle 11a and the first electrode tab bundle 11b, may be coupled to an upper surface of the first branch 313, and one electrode tab bundle, that is, the first electrode tab bundle 11c, may be coupled to an upper surface of the second branch 315. That is, different numbers of electrode tab bundles may be coupled to the first branch 313 and the second branch 315.

On the upper surface of the first branch 313, the first electrode tab bundle 11a and the first electrode tab bundle 11b may be bent towards each other along the thickness direction (x-axis direction) and be coupled thereto. The first electrode tab bundle 11a and the first electrode tab bundle 11b may be bent in opposite directions along the thickness direction (x-axis direction) and welded to the upper surface of the first branch 313.

On the upper surface of the second branch 315, one electrode tab bundle, that is, the first electrode tab bundle 11c may be bent in the same direction as an adjacent first electrode tab bundle 11b and coupled thereto.

Thus, the first electrode tab bundle 11b and the first electrode tab bundle 11c may be bent in the same direction, and the first electrode tab bundle 11a may be bent in a direction different from that of the first electrode tab bundle 11b and the first electrode tab bundle 11c and coupled on the branch.

In this case, the first width C1 of the first branch 313 and the second width C2 of the second branch 315 may satisfy the following [Equation 1].

$$\frac{1}{3} C 1 \leq C 2 \leq \frac{2}{3} C 1 \qquad [ Equation 1 ]$$

That is, the first width C1 of the first branch 313 may be approximately 1.5 times to 3 times the second width C2 of the second branch 315. When the first width C1 of the first branch 313 is less than 1.5 times the second width C2 of the second branch 315, portions of the first electrode tab bundle 11a and the first electrode tab bundle 11b coupled to the upper surface of the first branch 313 may overlap each other. As a result, electrical resistance caused by the first electrode tab bundle 11a and the first electrode tab bundle 11b coupled to the upper surface of the first branch 313 may increase, and coupling strength with the first current collector 310 may be weakened due to the overlap of the first electrode tab bundle 11a and the first electrode tab bundle 11b. On the other hand, when the first width C1 of the first branch 313 is greater than 3 times the second width C2 of the second branch 315, an area of the first current collector 310 may increase, such that resistance to current flowing through the first current collector 310 may increase.

Meanwhile, a first area S1, which may be C1*CC, of the first branch 313 and a second area S2, which may be C2*CC, of the second branch 315 may satisfy the following [Equation 2].

$$\frac{1}{3} S 1 \leq S 2 \leq \frac{2}{3} S 1 \qquad [ Equation 2 ]$$

That is, the first area S1 of the first branch 313 may be approximately 1.5 times to 3 times the second area S2 of the second branch 315. When the first area S1 of the first branch 313 is less than 1.5 times the second area S2 of the second branch 315, portions of the first electrode tab bundle 11a and the first electrode tab bundle 11b coupled to the upper surface of the first branch 313 may overlap each other. On the other hand, when the first area S1 of the first branch 313 is greater than 3 times the second area S2 of the second branch 315, an overall area of the first current collector 310 may increase, such that resistance to current flowing through the first current collector 310 may increase.

Meanwhile, the first width C1 of the first branch 313, the second width C2 of the second branch 315, and the separation distance CD may satisfy the following [Equation 3].

$$C 2 * 1 / 2 \leq CD \leq C 1 \qquad [ Equation 3 ]$$

That is, the separation distance CD may be less than or equal to the first width C1 of the first branch 313 and greater than or equal to one half of the second width C2 of the second branch 315. When the separation distance CD deviates from the above range, the electrode tab bundles coupled to the upper surfaces of the branches may not be coupled to the upper surfaces of the branches while protruding upward from central portions of the respective electrode assemblies. Instead, the electrode tab bundles may protrude upward from positions adjacent to side surfaces of the electrode assemblies, deviating from the central portions of the electrode assemblies, so as to be coupled to the upper surfaces of the branches. In this case, lengths of the electrode tab bundles protruding from the respective electrode assemblies increase as compared to a case in which the electrode tab bundles are disposed at central portions, thereby increasing manufacturing costs.

Further, a length CC of the first branch 313 and the second branch 315 in the width direction (y-axis direction) may be 0.6 to 0.9 times an overall length CB of the first current collector 310. That is, the length CC of the first branch 313 and the second branch 315 may occupy approximately one half or more of the overall length CB of the first current collector 310. In this case, a length IT1 of the first electrode tab bundles 11a, 11b, and 11c coupled to upper surfaces of the first branch 313 and the second branch 315 may be 0.7 to 0.95 times the length CC of the first branch 313 and the second branch 315. The length IT1 of the first electrode tab bundles 11a, 11b, and 11c may occupy approximately one half or more of the length CC of the first branch 313 and the second branch 315.

Meanwhile, the overall length of the current collectors 300, which is a sum of the length CB of the first current collector 310 and the length CB of the second current collector 330 in the width direction (y-axis direction), may be 0.5 to 0.75 times a length L1 of the electrode assembly stack 500. When the electrode assembly stack 500 is viewed from above, the above range may represent a ratio of a portion of the length of the electrode assembly stack 500 that is occupied by the entire current collectors 300 in the width direction (y-axis direction). When the overall length of the current collectors 300 exceeds the above range, a space occupied by the current collectors 300 in the width direction (y-axis direction) increases, thereby causing greater constraints on arranging the vent portion 50. The vent portion 50 is arranged in an empty space where the electrode tab, the current collector, and the like are not positioned in a vertical direction, that is, in a position where it does not overlap with the electrode tab, the current collector, and the like in the vertical direction. When the above range is exceeded, such empty space is reduced, and thus constraints on placement of the vent portion 50 may occur.

Therefore, as in this aspect, when the ratio occupied by the entire current collectors 300 satisfies the above range, the position of the vent portion 50 may be freely selected, and the direction of the vent portion 50 may be freely determined. Here, the direction of the vent portion 50 refers to a direction in which a longitudinal side of the vent portion 50 extends, and the vent portion 50 may be arranged in the width direction (y-axis direction), that is, horizontally, or may be arranged in the thickness direction (x-axis direction), that is, vertically.

In this aspect, the entire first current collector 310 may be formed as a single flat plate-shaped member, and the flatness of the first current collector 310 may be in a range of 0.05 mm to 2 mm. The flatness represents a degree to which the first current collector 310 is planar, and a smaller value indicates a flatter configuration. When the flatness of the first current collector 310 exceeds 2 mm, a portion of the first current collector 310 may come into contact with the upper surface of the electrode assembly 500 disposed below, thereby causing a short circuit or the like. Thus, when the flatness of the first current collector 310 falls within the corresponding range, even if the first electrode tab bundles 11a, 11b, and 11c are coupled to the upper surface of the first current collector 310, a short circuit with the electrode assembly stack 500 may be prevented.

Flatness may be a geometric dimension tolerance (GD&T) that specifies that all points on a surface must lie within a zone defined by two parallel planes. For example, when a flatness of a surface is 100 μm, the surface must be able to pass through a narrow 100 μm gap between two perfectly flat and parallel imaginary plates without any point on the surface making contact with either imaginary plate. The flatness may be measured by one or more methods, such as Surface Plate and Feeler Gauge, Dial Indicator Method, Coordinate Measuring Machine (CMM), Optical Interferometry, or Laser Scanning and Data Analysis. In a Surface Plate and Feeler Gauge, a workpiece is on a precision-machined surface plate, and any gaps between the plate and the part are measured using a feeler gauge. In the Dial Indicator Method, surface height variations are quantified by moving either the workpiece or a dial indicator across the surface of a workpiece to map out deviations in numerical values. In CMM, a contact probe captures 3D coordinate data of the surface of a workpiece, which is then analyzed by a software program to determine flatness. In Optical Interferometry, light interference patterns are used to measure ultra-high-precision flatness of a workpiece at the nanometer (nm) scale. In Laser Scanning and Data Analysis, laser sensors are used to scan the surface of a workpiece and generate a digital map for rapid inspection.

Flatness may be measured as a unitless value common in metal processing, such as the procedure under ASTM A1030 for measuring flatness characteristics of a metal sheet. The value of I-Units/Steepness I may be measured using the following Equation 4.

$$I = {( \frac{3.1415 \times H}{2 L} )}^{2} \times 1 {0}^{5} \qquad [ Equation 4 ]$$

In Equation 4, H may be the peak-to-peak height and L is peak-to-peak length. The unitless flatness I of the flat plate-shaped member of the first current collector 310 may be 0.05 to 2.

Meanwhile, the second current collector 330 may have a shape corresponding to the shape as the first current collector 310. The second current collector 330 may have the same shape as the first current collector 310. The second current 330 collector may have an inverse shape compared to the shape of the first current collector 310, such as a mirror image of the first current collector 310. In this aspect, the first current collector 310 and the second current collector 330 may be disposed symmetrically on the electrode assembly stack 500 with respect to the thickness direction (x-axis direction) of the electrode assembly stack 500.

The second current collector 330 may include a main support plate 331 and a plurality of branches 333 and 335. The main support plate 331 may be a flat plate-shaped member that supports a second connection terminal 337. The second connection terminal 337 may be positioned on an upper surface of the main support plate 331, and the second connection terminal 337 may be electrically connected to the second external terminal 24 coupled to the cap plate 21. In this case, the second connection terminal 337 may have a cylindrical shape.

The first and second branches 333 and 335 may be formed to extend from a side surface of the flat main support plate 331 along the width direction (y-axis direction). The first branch 333 and the second branch 335 may be spaced apart from each other along the thickness direction (x-axis direction).

As with the first current collector 310, widths of the first branch 333 and the second branch 335 of the second current collector 330 may be different from each other. Specifically, the width of the first branch 333 may be greater than the width of the second branch 335. Thereby, two negative-electrode tab bundles, that is, a second negative-electrode tab bundle 12a and another second negative-electrode tab bundle 12b, may be coupled to the upper surface of the first branch 333 of the second current collector 330. In addition, one negative-electrode tab bundle, that is, a further second negative-electrode tab bundle 12c, may be coupled to the upper surface of the second branch 335 of the second current collector 330.

In this aspect, a width of the first branch 333 of the second current collector 330, a width of the second branch 335, and a separation distance between the first branch 333 and the second branch 335 may be the same as those of the first current collector 310.

As illustrated in FIG. 4, the branches 313 and 315 of the first current collector 310 and branches 333 and 335 of the second current collector 330 may extend toward the center of the electrode assembly stack 500 along the width direction (y-axis direction) of the electrode assembly stack 500. That is, ends of the branches 313 and 315 of the first current collector 310 and ends of the branches 333 and 335 of the second current collector 330 may be disposed to face each other.

The first connection terminal 317 of the first current collector 310 and the second connection terminal 337 of the second current collector 330 may be disposed adjacent to opposite side ends of the electrode assembly stack 500 in the width direction (y-axis direction) of the electrode assembly stack 500. The first connection terminal 317 may be disposed adjacent to a left side end of the electrode assembly stack 500, and the second connection terminal 337 may be disposed adjacent to a right side end of the electrode assembly stack 500.

Referring to FIGS. 8 and 9, the first electrode tab bundle 11a of the first electrode assembly 510 is formed by closely fixing ends of uncoated portions of positive electrodes protruding upward from the first electrode assembly 510 to each other by a first welding. Before being coupled to the upper surface of the first current collector 310, the uncoated portions of the positive electrodes are gathered toward the center of the first electrode assembly 510 using a tab guide (not shown), and free ends of the gathered uncoated portions of the positive electrodes are fixed by the first welding. By the first welding, a first welding region PW1 may be formed at an end, such as a free end, of the first electrode tab bundle 11a of the positive electrodes.

In this case, the first welding may be formed to have a longitudinal dimension extending along the width direction (y-axis direction). The first welding may have various shapes, such as a linear shape, a spiral shape, or a dot shape.

The first welding is a welding performed to prevent the ends of the first electrode tab bundle 11a from being separated from each other while the first electrode tab bundle 11a is bent and fixed onto the first current collector 310. The first welding may correspond to a pre-welding in which only the ends of the first electrode tab bundle 11a are fixed to each other. In this case, ultrasonic welding, laser welding, or the like may be applied as the first welding. Preferably, the ultrasonic welding may be applied as the first welding.

Similarly, the first electrode tab bundle 11b of the first electrode assembly 530 and the first electrode tab bundle 11c of the first electrode assembly 550 may also be formed by coupling ends of uncoated portions of positive electrodes in the same manner to form bundles. Further, the same first welding regions PW1 may be formed at ends, such as free ends, of the first electrode tab bundles 11b and 11c of the positive electrodes by the first welding.

In addition, the second electrode tab bundles 12a, 12b, and 12c of the first electrode assembly 510 may also be formed by closely fixing ends of uncoated portions of negative electrodes to each other by the first welding. The second electrode tab bundle 12a, 12b, and 12c may be formed in the same manner as the first electrode tab bundles 11a, 11b, and 11c. In this case, by the first welding, first welding regions PW2 may be formed at ends of the second electrode tab bundle 12a, 12b, and 12c of the negative electrodes.

Referring again to FIGS. 4 to 7, the first electrode tab bundles 11a, 11b, and 11c of the electrode assembly stack 500 may be arranged in a line along the thickness direction (x-axis direction). That is, when viewed in the thickness direction (x-axis direction), the first electrode tab bundles 11a, 11b, and 11c may be arranged to overlap with each other. The first electrode tab bundles 11a, 11b, and 11c may all protrude from side ends at the same position of the positive electrode 11. In this aspect, since the second electrode tab bundles 12a, 12b, and 12c of the electrode assembly stack 500 have the same structure as the first electrode tab bundles 11a, 11b, and 11c, a detailed description thereof will be omitted.

Thereby, the ends of the first electrode tab bundles 11a, 11b, and 11c may be arranged in a line along the thickness direction (x-axis direction) and coupled to the upper surface of the first current collector 310. The ends of the first electrode tab bundles 11a, 11b, and 11c may be bent and coupled to the upper surface of the first current collector 310, and the first welding regions PW1 formed at the ends of the first electrode tab bundles 11a, 11b, and 11c may be positioned on the upper surface of the first current collector 310.

An upper side end of the first electrode tab bundle 11a and an upper side end of the first electrode tab bundle 11b may face each other and be positioned on the upper surface of the first branch 313 of the first current collector 310. Meanwhile, an upper side end of the first electrode tab bundle 11c may be positioned on the upper surface of the second branch 315 of the first current collector 310. Thereby, the first welding regions PW1 of the first electrode tab bundle 11a, the first electrode tab bundle 11b, and the first electrode tab bundle 11c may be arranged in a line and positioned on the first current collector 310.

In FIG. 5, the first electrode tab bundle 11a may be bent downward from the upper side of the electrode assembly stack 500 and coupled to the upper surface of the first branch 313, while the first electrode tab bundle 11b may be bent upward from the lower side of the electrode assembly stack 500 and coupled to the upper surface of the first branch 313. That is, the first electrode tab bundle 11a and the first electrode tab bundle 11b may be bent in directions facing each other and coupled to the upper surface of the first branch 313.

Meanwhile, the first electrode tab bundle 11c may be bent upward from the lower side of the electrode assembly stack 500 and coupled to the upper surface of the second branch 315. Alternatively, the first electrode tab bundle 11c may be bent downward from the upper side of the electrode assembly stack 500 and coupled to the upper surface of the second branch 315.

Therefore, in this aspect, the first electrode tab bundle 11b and the first electrode tab bundle 11c may be bent upward from the lower side of the electrode assembly stack 500, whereas the first electrode tab bundle 11a may be bent downward from the upper side of the electrode assembly stack 500, in a direction opposite to those of the first electrode tab bundle 11b and the first electrode tab bundle 11c.

In this aspect, the end of the first electrode tab bundle 11a may be coupled onto the first branch 313 by second welding. Specifically, after the end of the first electrode tab bundle 11a is bent and brought into close contact with the upper surface of the first branch 313, the second welding is performed on the end of the first electrode tab bundle 11a such that the end of the first electrode tab bundle 11a may be coupled onto the first branch 313.

The second welding may be performed on an upper-side portion of the first welding region PW1 of the first electrode tab bundle 11a so that the end of the first electrode tab bundle 11a is coupled to an upper surface of the first current collector 310. The second welding may be formed to have a longitudinal dimension extending along an extension direction of the first branch 313, that is, along the width direction (y-axis direction). In this case, the second welding may have various shapes, such as a linear shape, a spiral shape, or a dot shape.

The second welding is welding for fixing the end of the first electrode tab bundle 11a to the upper surface of the first current collector 310. The second welding may correspond to main welding that fixedly couples the first electrode tab bundle 11a onto the first current collector 310. In this case, laser welding, ultrasonic welding, or the like may be applied as the second welding. Preferably, the laser welding may be applied as the second welding.

Specifically, in this aspect, a second welding region MW1 formed at the end of the first electrode tab bundle 11a by the second welding may at least partially overlap with the first welding region PW1 formed at the end of the first electrode tab bundle 11a. Preferably, an entirety of the second welding region MW1 may overlap with the first welding region PW1. That is, the entire second welding region MW1 may be located within the first welding region PW1.

As illustrated in FIG. 5, an area of the first welding region PW1 may be formed to be larger than an area of the second welding region MW1. That is, a welding region formed by the first welding may have a larger area than a welding region formed by the second welding.

In this aspect, the area of the first welding region PW1 may be 1.1 to 5 times the area of the second welding region MW1. Since the ends of the first electrode tab bundle 11a are coupled to each other by the first welding before the second welding is performed, the ends of the first electrode tab bundle 11a may be firmly coupled to the upper surface of the first current collector 310 even when the area of the second welding region MW1 is smaller than the area of the first welding region PW1. That is, because the ends of the first electrode tab bundle 11a are firmly fixed in advance by the first welding, even when only a portion of the ends of the first electrode tab bundle 11a is fixed onto the first current collector 310 by the second welding, the ends of the first electrode tab bundle 11a may be firmly fixed to the upper surface of the first current collector 310.

Meanwhile, a length IT1 of the first welding region PW1 in the width direction (y-axis direction) may be greater than a length M1 of the second welding region MW1. In addition, a thickness W1 of the first welding region PW1 in the thickness direction (x-axis direction) may be greater than a thickness W2 of the second welding region MW1. Thereby, as described above, an area of the first welding region PW1 may be formed to be larger than an area of the second welding region MW1.

Referring to FIG. 7, the ends of the first electrode tab bundles 11a, 11b, and 11c are bent and fixed to the upper surfaces of the first branch 313 and second branch 315 of the first current collector 310, and portions other than the ends of the first electrode tab bundles 11a, 11b, and 11c may be maintained in a state bent toward the upper surface of the electrode assembly stack 500 by insulating tapes T1, T2, and T3. In this case, the insulating tapes T1, T2, and T3 may be positioned between the current collectors 300 and the upper surface of the electrode assembly stack 500.

A portion of the first electrode tab bundle 11a adjacent to the upper surface of the first electrode assembly 510 may be bent toward the upper surface of the first electrode assembly 510 and fixed by the insulating tape T1. A portion of the first electrode tab bundle 11b adjacent to the upper surface of the second electrode assembly 530 may be bent toward the upper surface of the second electrode assembly 530 and fixed by the insulating tape T2. A portion of the first electrode tab bundle 11c adjacent to the upper surface of the third electrode assembly 550 may be bent toward the upper surface of the third electrode assembly 550 and fixed by the insulating tape T3.

Hereinafter, a secondary battery according to a second aspect of the present disclosure will be described.

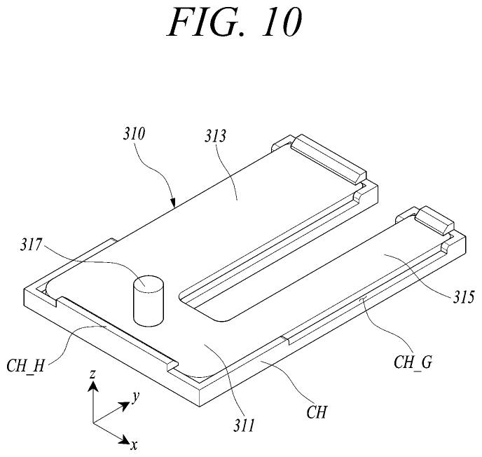

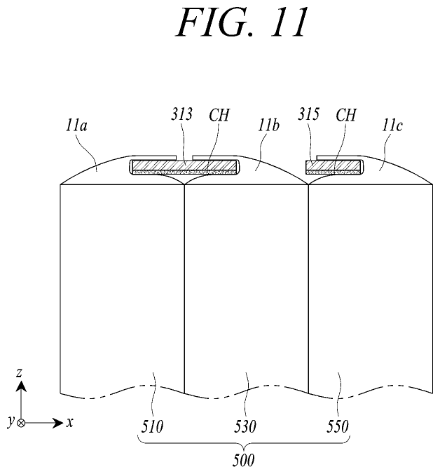

FIG. 10 is a perspective view illustrating a current collector according to a second aspect of the present disclosure, and FIG. 11 is a cross-sectional view illustrating a state in which the current collector of FIG. 10 is coupled to the electrode assembly stack 500.

Referring to FIGS. 10 and 11, since the secondary battery according to the second aspect has the same structure as the secondary battery according to the first aspect described above except for an insulating holder CH, a redundant description of the same components will be omitted.

In this aspect, the insulating holder CH may be disposed on a lower surface of the first current collector 310. The insulating holder CH may support and fix the first current collector 310 on the lower surface of the first current collector 310. In this aspect, an insulating holder CH coupled to the lower surface of the second current collector 330 has the same structure as the insulating holder CH of the first current collector 310, and thus a detailed description thereof will be omitted.

The insulating holder CH may prevent deformation or damage of the first current collector 310 during a welding process between the first electrode tab bundles 11a, 11b, and 11c and the first current collector 310, or while the first current collector 310 is positioned inside the casing 100.

When the first branch 313 and the second branch 315 of the first current collector 310 are deformed upwardly or downwardly, the first branch 313 and the second branch 315 may come into contact with the upper surface of the electrode assembly stack 500, thereby causing damage to the electrode assembly stack 500 or a short circuit. In addition, when the first branch 313 and the second branch 315 are deformed laterally, a distance between the first branch 313 and the second branch 315 may be changed, such that side portions of the first electrode tab bundles 11a, 11b, and 11c coupled to the upper surfaces of the first branch 313 and the second branch 315 may be damaged or cut. Therefore, in this aspect, the insulating holder CH may support and fix the first current collector 310, thereby preventing damage to or a short circuit of the electrode assembly stack 500 or the first electrode tab bundles 11a, 11b, and 11c.

The insulating holder CH may have a shape corresponding to a shape of the first current collector 310. In this case, the insulating holder CH may accommodate the first current collector 310 therein. The insulating holder CH may support the first current collector 310 while surrounding the lower and side surfaces of the accommodated first current collector 310. In order to prevent the first current collector 310 accommodated therein from being disengaged, a plurality of hooks CH_H may be disposed on side surfaces of the insulating holder CH. The first current collector 310 may be fixed inside the insulating holder CH by the plurality of hooks CH_H. In other examples, the plurality of hooks may be omitted and the insulating holder may be attached to the first current collector, such as by adhesive.

In order for the first electrode tab bundles 11a, 11b, and 11c to be bent and brought into contact with the upper surface of the first current collector 310, a cutout groove CH_G in which a portion of the side surface is cut away may be formed on the side surface of the insulating holder CH. When the first electrode tab bundles 11a, 11b, and 11c protruding from the electrode assembly stack 500 are bent and the bent first electrode tab bundles 11a, 11b, and 11c come into contact with the upper surface of the first current collector 310, the cutout groove CH_G may prevent the first electrode tab bundles 11a, 11b, and 11c from being interfered with by the side surface of the insulating holder CH.

Due to the cutout groove CH_G, a portion of the side surface of the first current collector 310 accommodated in the insulating holder CH may be exposed. In addition, due to the cutout groove CH_G, a contact area between the first current collector 310 and the first electrode tab bundles 11a, 11b, and 11c may be increased.

Hereinafter, a secondary battery according to a third aspect of the present disclosure will be described.

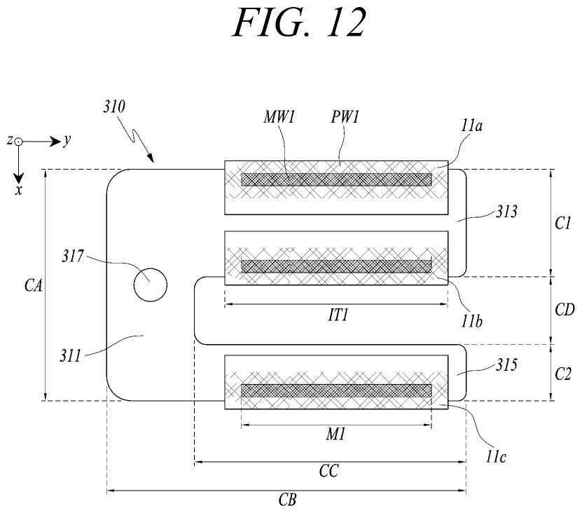

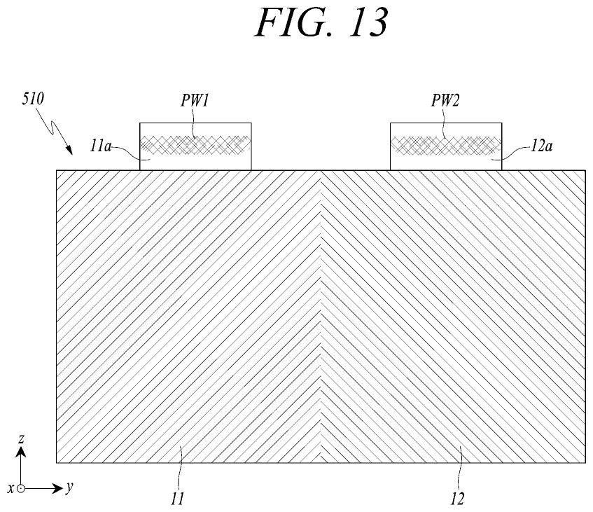

FIG. 12 is a plan view illustrating a state in which the electrode tab bundle is coupled to the current collector according to a third aspect of the present disclosure, and FIG. 13 is a side view illustrating an electrode in which the electrode tab bundle is formed according to the third aspect of the present disclosure

Referring to FIGS. 12 and 13, since a secondary battery according to the third aspect has the same structure as the secondary battery according to the first aspect described above except for the first electrode tab bundles 11a, 11b, and 11c, a redundant description of the same components will be omitted.

In this aspect, the first welding region PW1 may be formed at a position spaced apart from an upper side end of each of the first electrode tab bundles 11a, 11b, and 11c. In the above-described first aspect, the first welding region PW1 is formed at the upper side end of each of the first electrode tab bundles 11a, 11b, and 11c, such that only the first welding region PW1 is located at the side end of each of the first electrode tab bundles 11a, 11b, and 11c.

The first welding region PW1 is positioned at a location spaced apart from the upper side end of each first electrode tab bundle 11a, 11b, or 11c, and only an uncoated portion that is not welded is located at the side end. That is, only the uncoated portion that is not welded is positioned between the upper side end of each first electrode tab bundle 11a, 11b, or 11c and the first welding region PW1.

As illustrated in FIG. 12, not only the first welding region PW1 but also the uncoated portion of the first electrode tab bundle 11a and the uncoated portion of the first electrode tab bundle 11b may be positioned on the upper surface of the first branch 313 of the first current collector 310. In addition, on the upper surface of the first branch 313, the uncoated portions of the first electrode tab bundle 11a and the first electrode tab bundle 11b may be arranged side by side. An uncoated portion of the first electrode tab bundle 11c and the first welding region PW1 may be positioned on the upper surface of the second branch 315. The second welding region MW1 may be located to partially or fully overlap with the first welding region PW1. In this aspect, the second welding region MW1 may be positioned along an edge of the branches 313 and 315 in the thickness direction (y-axis direction) of the electrode assembly stack 500.

As the thickness of the electrode assemblies 510, 530, 550 in the electrode assembly stack 500 increase, the length of the uncoated portions increases to form the first electrode tab bundles 11a, 11b, and 11c. In order to maintain a constant distance between the upper surface of the electrode assembly stack 500 and the current collectors 300, as the length of the uncoated portion increases, the first welding region PW1 may be spaced apart from the upper side end of the first electrode tab bundle 11a, 11b, or 11c.

Hereinafter, a secondary battery according to a fourth aspect of the present disclosure will be described.

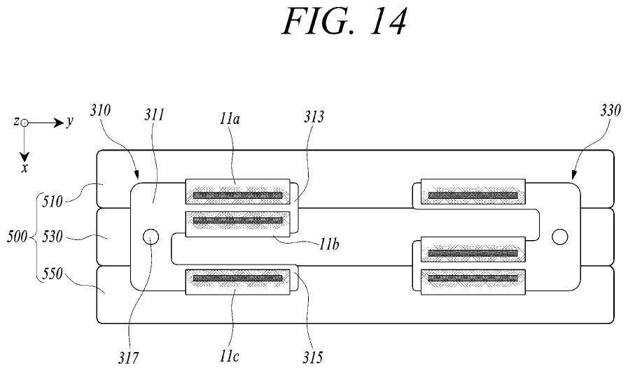

FIG. 14 is a plan view illustrating a state in which the current collector is coupled to the plurality of electrode assemblies according to a fourth aspect of the present disclosure.

Referring to FIG. 14, since the secondary battery according to the fourth aspect has the same structure as the secondary battery according to the first aspect described above except for the current collectors 300, a redundant description of the same components will be omitted.

In this aspect, the first current collector 310 and the second current collector 330 may have the same shape and be arranged symmetrically with respect to a virtual center point of the upper surface of the electrode assembly stack 500.

In the above-described first aspect, the first current collector 310 and the second current collector 330 may be arranged symmetrically on the electrode assembly stack 500 with respect to an axis parallel to the thickness direction (x-axis direction) of the electrode assembly stack 500. In this aspect, unlike the above, the first current collector 310 and the second current collector 330 may be arranged in point symmetry with respect to the virtual center point of the upper surface of the electrode assembly stack 500.

That is, when the first current collector 310 is rotated by 180 degrees, it may overlap the second current collector 330. Alternatively, when the second current collector 330 is rotated by 180 degrees, it may overlap the first current collector 310.

Hereinafter, a secondary battery according to a fifth aspect of the present disclosure will be described.

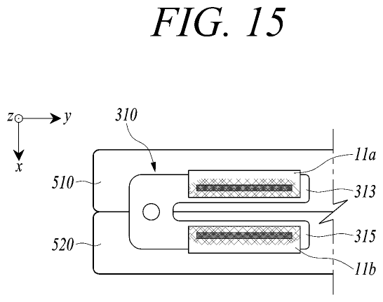

FIG. 15 is a partial plan view illustrating a state in which a current collector is coupled to a plurality of electrode assemblies according to a fifth aspect of the present disclosure.

Referring to FIG. 15, the secondary battery according to the fifth aspect has the same structure as the secondary battery according to the first aspect described above except for the current collectors 300 and the electrode assembly stack 500, and thus a redundant description of the same components will be omitted. Further, since the second current collector 330 has the same structure as the first current collector 310, a detailed description thereof will be omitted.

In this aspect, the electrode assembly stack 500 may include two electrode assemblies, namely, a first electrode assembly 510 and a second electrode assembly 520.

The first branch 313 and the second branch 315 of the first current collector 310 may have the same number of first electrode tab bundles 11a and 11b coupled thereto. That is, one first electrode tab bundle may be coupled to each of the first branch 313 and the second branch 315. The first electrode tab bundle 11a may be coupled to the upper surface of the first branch 313, and the first electrode tab bundle 11b may be coupled to the upper surface of the second branch 315.

In this case, the first branch 313 and the second branch 315 may have the same width. Thereby, an area of the first electrode tab bundle 11a coupled to the upper surface of the first branch 313 and an area of the first electrode tab bundle 11b coupled to the upper surface of the second branch 315 may be the same. Therefore, the branches of the first current collector 310 may be disposed to be symmetrical with respect to an axis parallel to the width direction (y-axis direction).

In FIG. 15, the first electrode tab bundle 11a may be bent downward from the upper side of the electrode assembly stack 500 and coupled to the upper surface of the first branch 313, and the first electrode tab bundle 11b may be bent upward from the lower side of the electrode assembly stack 500 and coupled to the upper surface of the second branch 315. That is, the first electrode tab bundle 11a and the first electrode tab bundle 11b may be bent in directions facing each other and coupled to the upper surfaces of the first branch 313 and the second branch 315.

Hereinafter, a secondary battery according to a sixth aspect of the present disclosure will be described.

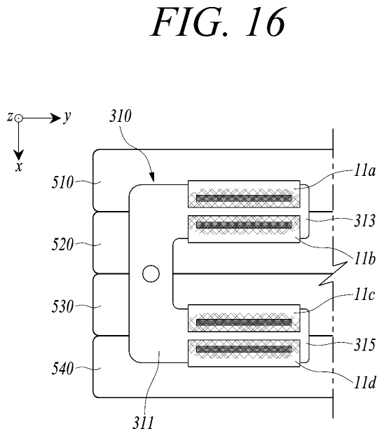

FIG. 16 is a partial plan view illustrating a state in which a current collector is coupled to a plurality of electrode assemblies according to a sixth aspect of the present disclosure.

Referring to FIG. 16, the secondary battery according to the sixth aspect has the same structure as the secondary battery according to the first aspect described above except for the current collectors 300 and the electrode assembly stack 500, and thus a redundant description of the same components will be omitted. In addition, since the second current collector 330 has the same structure as the first current collector 310, a detailed description thereof will be omitted.

In this aspect, the electrode assembly stack 500 may include four electrode assemblies, that is, a first electrode assembly 510, a second electrode assembly 520, a third electrode assembly 530, and a fourth electrode assembly 540. The four electrode assemblies may be stacked and arranged parallel to each other.

The first branch 313 and the second branch 315 of the first current collector 310 may have the same number of first electrode tab bundles 11a, 11b, 11c, and 11d coupled thereto. Two first electrode tab bundles 11a and 11b may be coupled to the first branch 313, and two first electrode tab bundles 11c and 11d may be coupled to the second branch 315.

On the upper surface of the first branch 313, the first electrode tab bundle 11a may be bent downward from the upper side and coupled to the upper surface of the first branch 313, and the first electrode tab bundle 11b may be bent upward from the lower side of the electrode assembly stack 500 and coupled to the upper surface of the first branch 313. That is, the first electrode tab bundle 11a and the first electrode tab bundle 11b may be bent in directions facing each other and coupled to the upper surface of the first branch 313.

On an upper surface of the second branch 315, the first electrode tab bundle 11c may be bent downward from the upper side and coupled to the upper surface of the second branch 315, and the first electrode tab bundle 11d may be bent upward from the lower side and coupled to the upper surface of the second branch 315. That is, the first electrode tab bundle 11c and the first electrode tab bundle 11d may be bent in directions facing each other and coupled to the upper surface of the second branch 315.

In addition, the first electrode tab bundles 11a, 11b, 11c, and 11d may be arranged in a line along the thickness direction (x-axis direction). That is, when viewed in the thickness direction (x-axis direction), the first electrode tab bundles 11a, 11b, 11c, and 11d may be arranged to overlap with each other.

In this case, the first branch 313 and the second branch 315 may have the same width. Thereby, an area of the first electrode tab bundles 11a and 11b coupled to the upper surface of the first branch 313 and an area of the first electrode tab bundles 11c and 11d coupled to the upper surface of the second branch 315 may be the same. Therefore, the first current collector 310 may be arranged to be symmetrical with respect to an axis parallel to the width direction (y-axis direction).

Hereinafter, a secondary battery according to a seventh aspect of the present disclosure will be described.

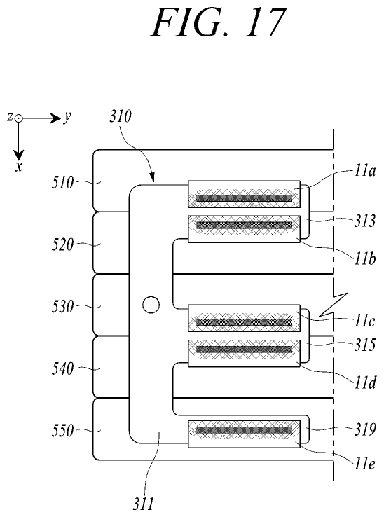

FIG. 17 is a partial plan view illustrating a state in which a current collector is coupled to a plurality of electrode assemblies according to a seventh aspect of the present disclosure.

Referring to FIG. 17, the secondary battery according to the seventh aspect has the same structure as the secondary battery according to the sixth aspect described above except for the current collectors 300 and the electrode assembly stack 500, and thus a redundant description of the same components will be omitted. In addition, since the second current collector 330 has the same structure as the first current collector 310, a detailed description thereof will be omitted.

In this aspect, the electrode assembly stack 500 may include five electrode assemblies, that is, a first electrode assembly 510, a second electrode assembly 520, a third electrode assembly 530, a fourth electrode assembly 540, and a fifth electrode assembly 550. The five electrode assemblies may be stacked and arranged parallel to each other.

The first current collector 310 may include a first branch 313, a second branch 315, and a third branch 319. Widths of the first branch 313 and the second branch 315 may be the same as each other, and the third branch 319 may be formed to have a smaller width than the first branch 313 and the second branch 315. The first current collector may be asymmetrical about a virtual center line extending in the width direction (y-axis direction) of the electrode assemblies.

Two first electrode tab bundles may be coupled to each of the first branch 313 and the second branch 315, and one first electrode tab bundle may be coupled to the third branch 319. The first electrode tab bundles 11a and 11b may be coupled to the upper surface of the first branch 313, and the first electrode tab bundles 11c and 11d may be coupled to the upper surface of the second branch 315. A first electrode tab bundle 11e may be coupled to an upper surface of the third branch 319.

On an upper surface of the first branch 313, the first electrode tab bundle 11a may be bent downward from the upper side and coupled to the upper surface of the first branch 313, and the first electrode tab bundle 11b may be bent upward from the lower side of the electrode assembly stack 500 and coupled to the upper surface of the first branch 313. That is, the first electrode tab bundle 11a and the first electrode tab bundle 11b may be bent in directions facing each other and coupled to the upper surface of the first branch 313.

On an upper surface of the second branch 315, the first electrode tab bundle 11c may be bent downward from the upper side and coupled to the upper surface of the second branch 315, and the first electrode tab bundle 11d may be bent upward from the lower side and coupled to the upper surface of the second branch 315. That is, the first electrode tab bundle 11c and the first electrode tab bundle 11d may be bent in directions facing each other and coupled to the upper surface of the second branch 315.

On an upper surface of the third branch 319, the first electrode tab bundle 11e may be bent upward from the lower side and coupled to the upper surface of the third branch 319. However, the first electrode tab bundle 11e may be bent downward from the upper side and coupled to the upper surface of the third branch 319, without being limited thereto.

In addition, the first electrode tab bundles 11a, 11b, 11c, 11d, and 11e may be arranged in a line along the thickness direction (x-axis direction). That is, when viewed in the thickness direction (x-axis direction), the first electrode tab bundles 11a, 11b, 11c, 11d, and 11e may be arranged to overlap with each other.

Hereinafter, a secondary battery according to an eighth aspect of the present disclosure will be described.

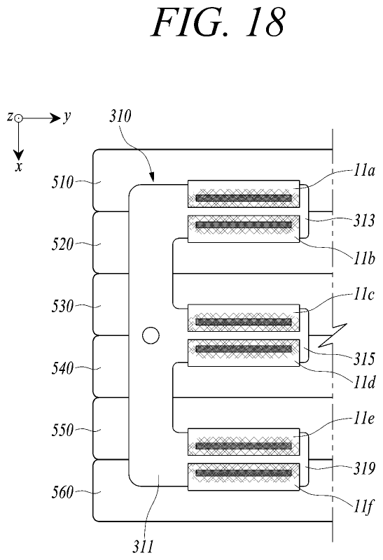

FIG. 18 is a partial plan view illustrating a state in which a current collector is coupled to a plurality of electrode assemblies according to the eighth aspect of the present disclosure.

Referring to FIG. 18, the secondary battery according to the eighth aspect has the same structure as the secondary battery according to the seventh aspect described above except for the current collectors 300 and the electrode assembly stack 500, and thus a redundant description of the same components will be omitted. In addition, since the second current collector 330 has the same structure as the first current collector 310, a detailed description thereof will be omitted.

In this aspect, the electrode assembly stack 500 may include six electrode assemblies, that is, a first electrode assembly 510, a second electrode assembly 520, a third electrode assembly 530, a fourth electrode assembly 540, a fifth electrode assembly 550, and a sixth electrode assembly 560. The six electrode assemblies may be stacked and arranged parallel to each other.

A first branch 313, a second branch 315, and a third branch 319 of the first current collector 310 may have the same number of first electrode tab bundles 11a, 11b, 11c, 11d, 11e, and 11f coupled thereto. Two first electrode tab bundles may be coupled to each of the first branch 313 to the third branch 319.

The first electrode tab bundles 11e and 11f may be coupled to an upper surface of the third branch 319. The first electrode tab bundle 11e may be bent downward from an upper side and coupled to the upper surface of the third branch 319, and the first electrode tab bundle 11f may be bent upward from a lower side and coupled to the upper surface of the third branch 319.

In this case, the first branch 313, the second branch 315, and the third branch 319 may have the same width. Thereby, an area of the first electrode tab bundles 11a and 11b coupled to the upper surface of the first branch 313, an area of the first electrode tab bundles 11c and 11d coupled to the upper surface of the second branch 315, and an area of the first electrode tab bundles 11e and 11f coupled to the upper surface of the third branch 319 may be the same. Therefore, the branches of the first current collector 310 may be arranged to be symmetrical with respect to an axis parallel to the width direction (y-axis direction).

Hereinafter, a secondary battery according to a ninth aspect of the present disclosure will be described.

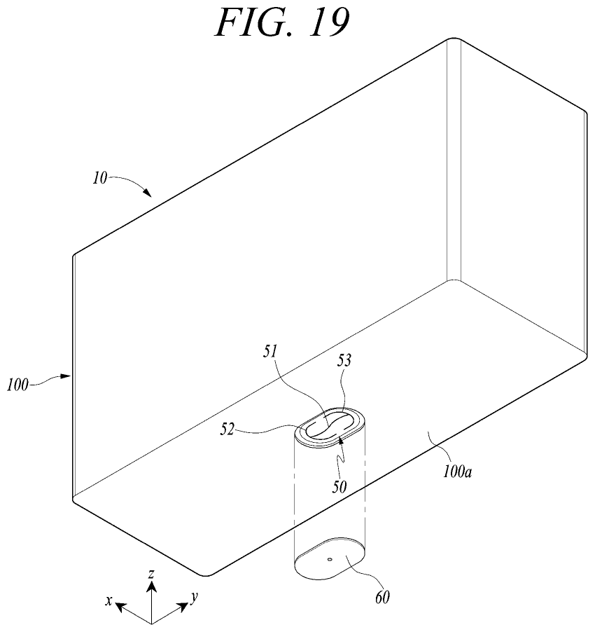

FIG. 19 is a perspective view illustrating a vent portion according to the ninth aspect of the present disclosure, as viewed from below.

Referring to FIG. 19, the secondary battery according to the ninth aspect has the same structure as the secondary battery according to the first aspect described above except for the vent portion 50, and thus a redundant description of the same components will be omitted.

In this aspect, the secondary battery 10 may be a prismatic battery having a substantially rectangular parallelepiped-shaped casing 100, and the vent portion 50 may be fixed to a bottom 100a of the casing 100. The bottom 100a of the casing 100 may be formed integrally with the casing 100 or may be fixed to the casing 100, such as by welding or adhesive.

An exhaust hole for discharging gas may be formed in the bottom 100a of the casing 100, the vent portion 50 may be inserted into a lower outer side of the exhaust hole, and a vent protection film 60 may be disposed on a lower outer side of the vent portion 50.

The vent portion 50 may be formed in a plate shape and may be fixed to the casing 100 by welding. The vent portion 50 may have a longitudinal dimension extending along the width direction (y-axis direction) of the bottom of the casing.

The vent portion 50 may include two side notches 52 and 53 and a connection notch 51 connecting the side notches 52 and 53. Since the connection notch 51 and the side notches 52 and 53 have the same structure as the connection notch and the side notches according to the above-described first aspect, a redundant description thereof will be omitted.

Meanwhile, the vent protection film 60 may be installed at a lower portion of the vent portion 50. The vent protection film 60 may be formed of a flexible film, and a connection hole for discharging pressure may be formed in the vent protection film 60.

As described above, according to the ninth aspect, since the vent portion 50 is formed at the bottom 100a of the casing 100, an electrolyte may also be discharged together when the vent portion 50 is opened.

Hereinafter, a secondary battery according to a tenth aspect of the present disclosure will be described.

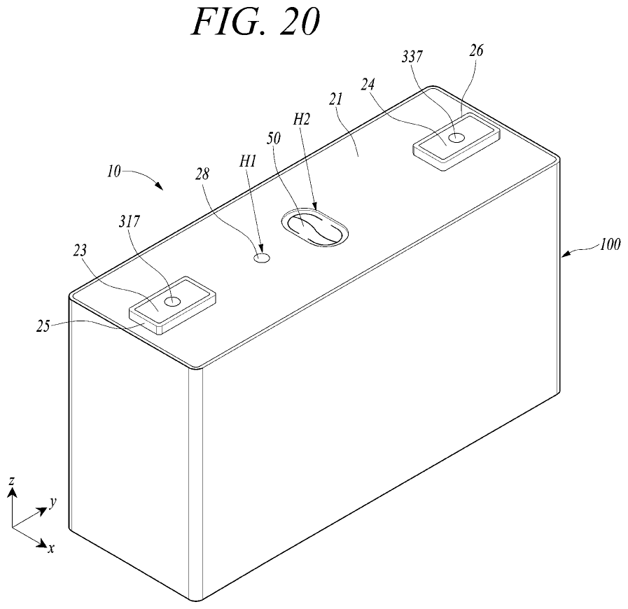

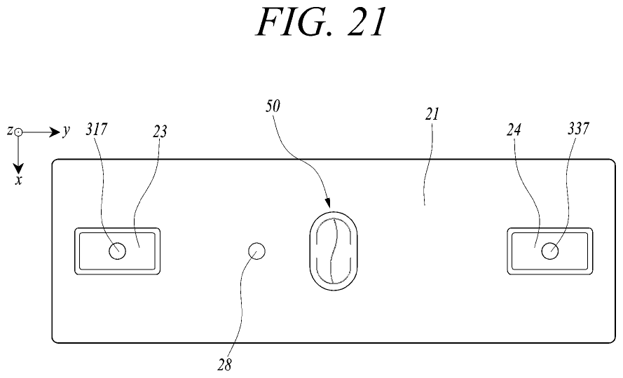

FIG. 20 is a perspective view illustrating the secondary battery according to the tenth aspect of the present disclosure, and FIG. 21 is a plan view illustrating the secondary battery of FIG. 20 as viewed from above.

Referring to FIGS. 20 and 21, the secondary battery according to the tenth aspect has the same structure as the secondary battery according to the first aspect described above except for the vent portion 50, and thus a redundant description of the same components will be omitted.

In this aspect, the vent portion 50 may longitudinally extend along the thickness direction (x-axis direction). The vent portion 50 may have a shape elongated in the thickness direction (x-axis direction) of the casing 100, such as a rectangular shape, an oblong shape, or a rounded-rectangle shape. In the above-described first aspect, the vent portion 50 is formed to longitudinally extend along the width direction (y-axis direction), whereas in this aspect, the vent portion 50 is formed to longitudinally extend along the thickness direction (x-axis direction) of the casing 100, which intersects the direction of the vent portion 50 of the first aspect.

The vent portion 50 may be fixed to the cap plate 21, such as by welding or adhesive. The vent portion 50 may be fixed to a lower surface of the cap plate 21, or may alternatively be fixed to an upper surface of the cap plate 21.

In this aspect, as the plurality of electrode assemblies 510, 530, 550 are stacked and the thickness of the cap plate 21 increases in a direction parallel to the thickness direction (x-axis direction) of the casing 100, the vent portion 50 may be disposed in the thickness direction (x-axis direction) of the casing 100. Thereby, during gas discharge, the vent portion 50 is not interfered with by the first current collector 310 and the second current collector 330 positioned below, and thus the vent portion 50 may smoothly discharge gas.

Hereinafter, a secondary battery according to an eleventh aspect of the present disclosure will be described.

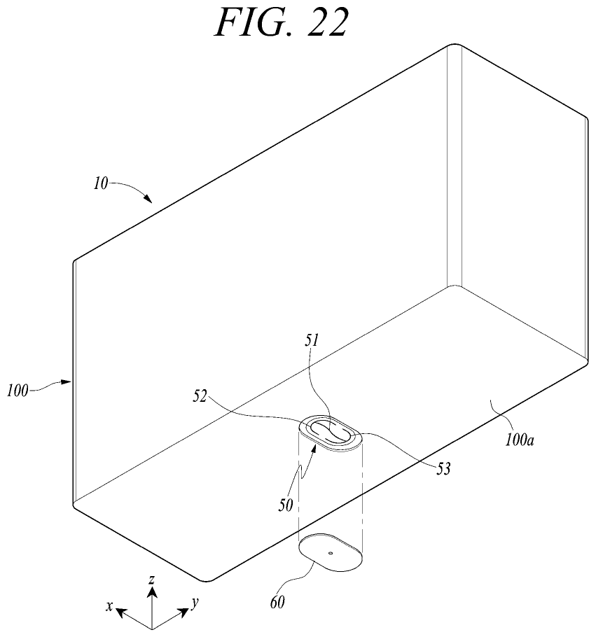

FIG. 22 is a perspective view illustrating a vent portion according to the eleventh aspect of the present disclosure, as viewed from below.

Referring to FIG. 22, the secondary battery according to the eleventh aspect has the same structure as the secondary battery according to the tenth aspect described above except for the vent portion 50, and thus a redundant description of the same components will be omitted.

In this aspect, the secondary battery 10 may be a prismatic battery having a substantially rectangular parallelepiped-shaped casing 100, and the vent portion 50 may be fixed to a bottom 100a of the casing 100. The bottom 100a of the casing 100 may be formed integrally with the casing 100 or may be fixed to the casing 100, such as by welding or adhesive.

An exhaust hole for discharging gas may be formed in the bottom 100a of the casing 100, the vent portion 50 may be inserted into a lower outer side of the exhaust hole, and a vent protection film 60 may be disposed on a lower outer side of the vent portion 50.

The vent portion 50 may be formed in a plate shape and may be fixed to the casing 100, such as by welding or adhesive.

The vent portion 50 may longitudinally extend along the thickness direction (x-axis direction) of the casing 100. The vent portion 50 may have a shape elongated in the thickness direction (x-axis direction), such as a rectangular shape, an oblong shape, or a rounded-rectangle shape.

Meanwhile, a vent protection film 60 may be installed below the vent portion 50. The vent protection film 60 may be formed of a flexible film, and a connection hole for discharging pressure may be formed in the vent protection film 60.

As described above, according to the eleventh aspect, since the vent portion 50 is formed at the bottom 100a of the casing 100, an electrolyte may also be discharged together when the vent portion 50 is opened.

According to one aspect of the present disclosure, a secondary battery can increase energy density per unit volume by reducing a space occupied by a thin film tab and the like within a casing.

Further, according to one aspect of the present disclosure, the secondary battery can reduce resistance to current caused by an increase in a length of a thin film tab in a process in which current is delivered to an electrode assembly stack 500 through an external terminal.

Furthermore, according to one aspect of the present disclosure, the secondary battery can stably connect a thin film tab to a current collector as the number of electrode assemblies increases.

While the present disclosure has been described with respect to the specific aspects, it will be apparent to those skilled in the art that various changes or modifications of the present disclosure are possible by adding, changing, or deleting components without departing from the spirit of the present disclosure as defined in the following claims.

What is claimed is:

1. A secondary battery, comprising:
a casing;
an electrode assembly stack including a plurality of electrode assemblies accommodated in the casing, each electrode assembly including a plurality of electrodes having electrode tabs;
a plurality of electrode tab bundles formed from the electrode tabs of the plurality of electrode assemblies, respectively;
a current collector coupled to the plurality of electrode tab bundles; and
a cap assembly sealing the casing and having an external terminal connected to the current collector,
wherein the current collector includes:
a main support plate on which a connection terminal connected to the external terminal is positioned, and
a plurality of branches extending from a side of the main support plate along a width direction of the electrode assemblies, the electrode tab bundles being coupled thereto,
wherein the plurality of branches includes a first branch and a second branch that are spaced apart from each other in a thickness direction of the electrode assembly stack, the thickness direction of the electrode assembly stack intersecting the width direction of the electrode assemblies, and
wherein the current collector is asymmetrical about a virtual center line extending in the width direction of the electrode assemblies.

2. The secondary battery according to claim 1, wherein each electrode tab bundle is formed by gathered electrode tabs welded together over a first welding region at a free end of the electrode tab bundle.

3. The secondary battery according to claim 2, wherein the free end of each electrode tab bundle of the plurality of electrode tab bundles is welded onto a branch of the plurality of branches over a second welding region on each electrode tab bundle of the plurality of electrode tab bundles.

4. The secondary battery according to claim 3, wherein the second welding region of each electrode tab bundle of the plurality of electrode tab bundles at least partially overlaps the first welding region, respectively.

5. The secondary battery according to claim 4, wherein the second welding region is located within the first welding region.

6. The secondary battery according to claim 3, wherein an area of the first welding region is 1.1 to 5 times an area of the second welding region.

7. The secondary battery according to claim 6, wherein a length of the first welding region in the width direction of the electrode assemblies is greater than a length of the second welding region in the width direction of the electrode assemblies.

8. The secondary battery according to claim 1, wherein a number of electrode tab bundles of the plurality of electrode tab bundles welded to the first branch is different from a number of electrode tab bundles of the plurality of electrode tab bundles welded to the second branch.

9. The secondary battery according to claim 8, wherein two electrode tab bundles of the plurality of electrode tab bundles are welded to the first branch, and one electrode tab bundle of the plurality of electrode tab bundles is welded to the second branch.

10. The secondary battery according to claim 9, wherein the two electrode tab bundles and the one electrode tab bundle are arranged in a line along the thickness direction of the electrode assembly stack.

11. The secondary battery according to claim 10, wherein:
the two electrode tab bundles are bent towards each other along the thickness direction of the electrode assembly stack and are welded onto the first branch, and
the one electrode tab bundle is bent in the same direction as an adjacent one of the two electrode tab bundles and the one electrode tab bundle is welded onto the second branch.

12. The secondary battery according to claim 11, wherein:
the plurality of electrode assemblies includes three electrode assemblies arranged in parallel along the thickness direction of the electrode assembly stack, and
an electrode tab bundle of the plurality of electrode tab bundles is disposed on each of the three electrode assemblies.

13. The secondary battery according to claim 9, wherein a first width of the first branch in the thickness direction of the electrode assembly stack is greater than a second width of the second branch in the thickness direction of the electrode assembly stack.

14. The secondary battery according to claim 13, wherein the first width of the first branch and the second width of the second branch satisfy Equation 1 below:
$$\frac{1}{3} C 1 \leq C 2 \leq \frac{2}{3} C 1 \qquad [ Equation 1 ]$$
where C1 represents the first width, and C2 represents the second width.

15. The secondary battery according to claim 14, wherein a first area of the first branch and a second area of the second branch satisfy Equation 2 below:
$$\frac{1}{3} S 1 \leq S 2 \leq \frac{2}{3} S 1 \qquad [ Equation 2 ]$$
where S1 represents the first area, and S2 represents the second area.

16. The secondary battery according to claim 13, wherein a separation distance between the first branch and the second branch satisfies Equation 3 below:
$$C 2 * 1 / 2 \leq CD \leq C 1 \qquad [ Equation 3 ]$$
where C1 represents the first width, C2 represents the second width, and CD represents the separation distance between the first branch and the second branch.

17. The secondary battery according to claim 1, wherein each of the electrode tab bundles of the plurality of electrode tab bundles is welded onto an upper surface of the first branch or the second branch.

18. The secondary battery according to claim 1, wherein a number of electrode tab bundles of the plurality of electrode tab bundles welded to the first branch equals a number of electrode tab bundles of the plurality of electrode tab bundles welded to the second branch.

19. The secondary battery according to claim 1, wherein the connection terminal is disposed adjacent to an end of the electrode assembly in the width direction of the electrode assemblies.

20. The secondary battery according to claim 1, wherein the main support plate and the plurality of branches lie in the same plane.

21. The secondary battery according to claim 20, wherein a flatness of the main support plate and the plurality of branches is 0.05 mm to 2 mm.

22. The secondary battery according to claim 1, wherein an overall length of the current collector in the width direction of the electrode assemblies is 0.5 to 0.75 times a length of the electrode assembly stack in the width direction of the electrode assemblies.

23. The secondary battery according to claim 1, wherein an insulating holder supporting the current collector covers a lower side of the current collector.

24. The secondary battery according to claim 1, wherein:
at least a portion of each electrode tab bundle of the plurality of electrode tab bundles is bent to be parallel to an upper surface of the electrode assembly stack, and
an insulating tape is disposed between the current collector and the upper surface of the electrode assembly.

25. The secondary battery according to claim 1,
further comprising a vent portion formed in the casing or the cap assembly,
wherein a longitudinal axis direction of the vent portion is parallel to the width direction of the electrode assemblies or intersects the width direction of the electrode assemblies.

26. The secondary battery according to claim 4, wherein the second welding region of each electrode tab bundle of the plurality of electrode tab bundles is positioned along an edge of a respective branch of the plurality of branches.

27. The secondary battery according to claim 1, wherein the plurality of electrode tab bundles is a first plurality of electrode tab bundles and the current collector is a first current collector, and the secondary battery further comprises:
a second plurality of electrode tab bundles formed from electrode tabs of the plurality of electrode assemblies, respectively, and
a second current collector coupled to the second plurality of electrode tab bundles, the second current collector including:
a main support plate on which a connection terminal connected to a second external terminal is positioned, and
a plurality of branches extending from a side of the main support plate along the width direction of the electrode assemblies, the second plurality of electrode tab bundles being coupled thereto;
wherein the plurality of branches includes a first branch and a second branch that are spaced apart from each other in the thickness direction of the electrode assembly stack, the thickness direction of the electrode assembly stack intersecting the width direction of the electrode assemblies, and
wherein the second current collector is asymmetrical about a virtual center line extending in the width direction of the electrode assemblies.

28. The secondary battery according to claim 27, wherein the first current collector has a shape corresponding to a shape of the second current collector.

29. The secondary battery according to claim 28, wherein the first current collector and the second current collector are arranged in mirror symmetry on the electrode assembly stack with respect to the thickness direction of the electrode assembly stack.

30. The secondary battery according to claim 28, wherein the first current collector and the second current collector are arranged in point symmetry on the electrode assembly stack with respect to a virtual center point on an upper surface of the electrode assembly stack.
